(19) United States
(12) Patent Application Publication
(10) Pub. No.: US 2007/0172959 A1
(43) Pub. Date: Jul. 26, 2007

(54) Method and device for electrically testing fuels and combustibles by generating a plasma

(76) Inventors: Jörg Füllemann, Mastrils (CH); Roman Koch, Chur (CH)

Correspondence Address: MORRISS OBRYANT COMPAGNI, P.C., 734 EAST 200 SOUTH, SALT LAKE CITY, UT, 84102, US

(21) Appl. No.: 10/583,418

(22) PCT Filed: Nov. 19, 2004
(86) PCT No.: PCT/EP04/53022

§ 371 Date: Mar. 28, 2007

(30) Foreign Application Priority Data
Dec. 15, 2003 (CH) 2141/03
Dec. 18, 2003 (CH) 2178/03

(51) Int. Cl. G01N 27/00

(52) U.S. Cl. 436/149

(57) ABSTRACT

The invention relates to a method for testing liquid and gaseous fuels and combustibles in general and testing the erosivity of low-sulfur combustibles in particular. According to said method, a plasma is formed with the combustible or fuel, and the electrical behavior of the plasma is measured. The more dielectric the plasma of an untreated batch of combustible or fuel behaves, the less risk-prone is the combustible or fuel regarding erosivity. The conductivity of the plasma can be increased or lowered by adding additives in order to obtain an unproblematic fuel or combustible. The measured values of the voltage peaks of the half-wave of an alternating voltage applied to the plasma of combustibles and fuels that are treated by means of additives must be lower or significantly greater than the measured values of a combustible or fuel which is unproblematic already in an untreated state, said half-wave being inverted by the plasma. Advantageously, the average maximum values of both half-waves are taken into account for assessing the erositivity of a combustible.

The invention relates to a method for testing liquid and gaseous fuels and combustibles, as well as to their combustion conditions.

Extra light low-sulfur heating oil with a sulfur content of less than 500 ppm, and particularly with a sulfur content of less than 50 ppm or even less than 30 ppm, as required by newer standards, has erosive characteristics. These erosive characteristics become apparent by the erosion of material on the metal parts of the heating system on the combustion chamber side during the combustion of heating oil in a heating system and are referred to as “metal dusting”. This damaging effect develops with variable speed. The metal erosion, however, is not only dependent on the sulfur content, but is rather batch-specific. Presently, studies are being conducted as to the cause of these erosive properties and also the strong erosivity variations of different heating oil batches.

The term erosivity in this invention relates to the tendency of heating oil or fuel to cause metal erosions of the new kind that is typical for low-sulfur combustibles and fuels. Such metal erosions, occasionally referred to as corrosion or low-temperature corrosion, are increasingly referred to as “metal dusting”.

Findings have not yet been provided by chemical and physical analyses in terms of a cause for this erosive impact of low-sulfur combustibles.

The erosivity of different heating oil batches was examined with the testing method disclosed in WO 03027668. This method provides reliable findings after only a few hours of testing. It was determined that eliminating the erosivity was possible by adding an additive to the heating oil.

It is the object of the present invention to provide a testing method, which determines a characteristic, such as erosivity, of combustible conditions within just a few minutes. This characteristic of the combustible conditions can be associated with a characteristic of a liquid or gaseous combustible or fuel, as is the case particularly for erosivity, which often is innate to low-sulfur heating oil and low-sulfur fuel, or also with a characteristic of the environment of the combustion process.

When a method of this kind is available, it permits to quickly establish the influence a measure has on the observed characteristic of the fuel or combustible, as for example changes to the refining process and/or adding an additive. This permits a quick and empiric method for searching for a solution to a recognized problem.

It can be assumed that such a method permits the study of changes to the combustion conditions, as for example the electrical isolation or the specific electrical charge of combustion chamber parts, or the influence on the combustion conditions, such as by means of a sacrificial electrode.

On the basis of the above-described results obtained with the testing method disclosed in WO 03027886 it was possible to develop a novel testing method and also test it based on the method disclosed in WO 03027886.

With the method according to invention, a plasma is formed with the combustible and fuels for testing liquid and gaseous fuels and combustibles, and the electrical behavior of the plasma and/or the electrical behavior of the plasma environment are measured. The term plasma in this application relates to an at least partially ionized medium. Advantageously, the potential and/or the current flow between two test electrodes disposed in the plasma are measured. During the measuring of the electrical behavior, the plasma is advantageously exposed to an electrical voltage field. The test electrodes can however also be disposed in the plasma environment. A potential is also measurable in the combustion gas outside the flame of the burning combustible or fuel.

This way, crucial combustible or fuel behavior characteristics can be recorded and analyzed. Measuring of the voltage between test electrodes can be carried out within milliseconds or nanoseconds, and the voltage curve can, for example, be directly represented and analyzed using an oscillograph.

Advantageously, an alternating voltage field is inserted into the plasma even if a direct voltage can be applied to the plasma. Subjecting the plasma to an alternating or direct voltage amplifies the measurable signals. An oscillating voltage in the test electrodes is achieved by introducing an alternating voltage into the plasma, which oscillating voltage is simple to illustrate and is very meaningful in terms of, for example, the erosivity of a combustible.

Suitably an alternating voltage field is applied to the plasma by two electrodes disposed therein.

In a combustible or fuel plasma, an applied alternating voltage is rectified. The test electrodes are therefore used to measure a direct voltage essentially oscillating between zero and a maximum potential, specifically in terms of the direction of the potential, independently of the direction in which the voltage is rectified in the alternating voltage field. The amplitude of these measured rectified oscillations, however, depends on the voltage direction in the alternating voltage field. The apex of the converted voltage has a smaller potential than the apex of the non-converted voltage.

It has been found that the maximum value of the wave curve converted by the rectification and therefore reflected contains information about the erosivity of the tested material. This way, the erosivity of a combustible or fuel can be determined quickly by assessing this maximum value.

So far no verified theoretical models are available yet, which would explain the erosivity of a combustible. Theoretical findings will probably not be available either for future applications of the testing method, but instead only a phenomenologically described diagnostic finding, such as the erosivity of heating oil, will be provided. The search for a solution will therefore bring about the analysis of measures, wherein the conditions during testing of the measures should correspond as closely as possible to the conditions in which the observed phenomenon arises. Conformity with these conditions guarantees that the changes of the observed phenomenon produced in the test device are also produced in the environment in which the phenomenon was originally observed and where, for example, it is supposed to be prevented.

For testing the erosivity of heating oil, the combustible is advantageously ignited and burned with an oxygen-containing gas. It is necessary to feed an oxygen-containing gas, in particular air, to the atomized combustible.

A test device for testing combustible and fuel comprises a plasma chamber or combustion chamber, a device for introducing combustible or fuel in the plasma chamber and means for generating a plasma from this combustible or fuel. Furthermore, a cathode and an anode are present as test electrodes, as well as a device for measuring and electronically processing electrical values determined by these test electrodes.

Advantageously, a test device for carrying out the testing method according to invention is also suited for carrying out the testing method as disclosed in WO 03027668. This allows the respective visual follow-up verification of the electrically and electronically determined results. The test specimen, for example the evaporator or mixer tube, serves as an anode for visually testing the erosion.

To be able to compare several test results, in a preferred test device a series of parameters are preferably kept constant when testing by means of the method according to invention.

Such parameters are particularly the geometry, the material, and the temperature of a test specimen. A test specimen is understood to be a metal part disposed at the combustion site, preferably a mixer tube and/or evaporator of a burner, on which damaging effects caused by erosion become visible. Furthermore, the geometries, the materials and the positions of the test electrodes, the CO₂-content of the combustion gas, the O₂-content, the CO-content, the CxHy-content in the combustion gas, soot, soot particles, and SO—, SO2-, NO—, NO2-contents in the combustion gas are parameters, which should be kept very constant. This also applies to the pressure of the test medium in front of the nozzle, the nozzle type, the nozzle spraying angle and so forth, the pressure in the evaporation zone and/or the combustion zone, the pressure at the air intake opening, the temperature and the relative humidity of the combustion air, the combustion efficiency, the combustion chamber geometry, the material of a combustion chamber cooling system, the temperature of the combustion chamber cooling system, and the geometry of the air flow at entry of the combustion air into the evaporator (test specimen). However, the quantity of combustible can vary depending on the energy content of the combustible.

In terms of relative humidity, air pressure, and air quantity, it is substantially only of importance that the supplied oxygen quantity corresponds to the efficiency and desired residual oxygen content. Variations in the relative humidity can therefore be compensated by varying the pressure and quantity levels.

For safe testing of the method and test device, it is also advantageous to always use the same reference combustible or reference fuel. Reference measurements with this reference combustible or fuel are advantageously carried out before and after each fuel or combustible testing. Preferably two reference combustibles with different behaviors are used, such as for example an uncritical and a critical combustible. This results in two fixed points for testing the test device.

A cathode and an anode are necessarily provided as test electrodes in a device used to test the erosivity of the combustion conditions during the combustion of a combustible and fuel in a combustion chamber. The anode can be formed by a portion of the combustion chamber, for example a heat exchanger of a gas heater. Furthermore, a device must be provided for measuring and electronically processing electrical values determined by the test electrodes. Such a device can be integrated into an existing combustion chamber, which provides testing of actually existing conditions during the combustion of, for example, gas. The influence which measures such as the creation of counter-potentials or the attachment of a sacrificial anode have on these conditions can also be measured.

To prevent erosive combustion conditions, therefore not only the combustible or fuel can be influenced and this influence can be tested. The environment in which the combustion takes place can also be influenced. Therefore a device for preventing erosion on the combustion chamber parts during the combustion of liquid of gaseous combustible is provided. Such a device comprises means for influencing the potential in a plasma of the combustible. Such means are particularly one or two electrodes and one voltage source connected thereto, or a sacrificial anode. The device can also comprise both means. Combustion chambers, in which erosive conditions prevail, can be retrofitted with these devices. Testing of the retrofitted system is then possible with the method or test device according to invention.

The invention will be explained in more details hereinafter with reference to examples, which are limited to the testing of the erosive properties of extra light low-sulfur heating oil (which, as is generally known, largely corresponds to Diesel fuel).

The invention, however, can also be applied to the testing of other combustible and fuel properties and the testing of combustion conditions, wherein:

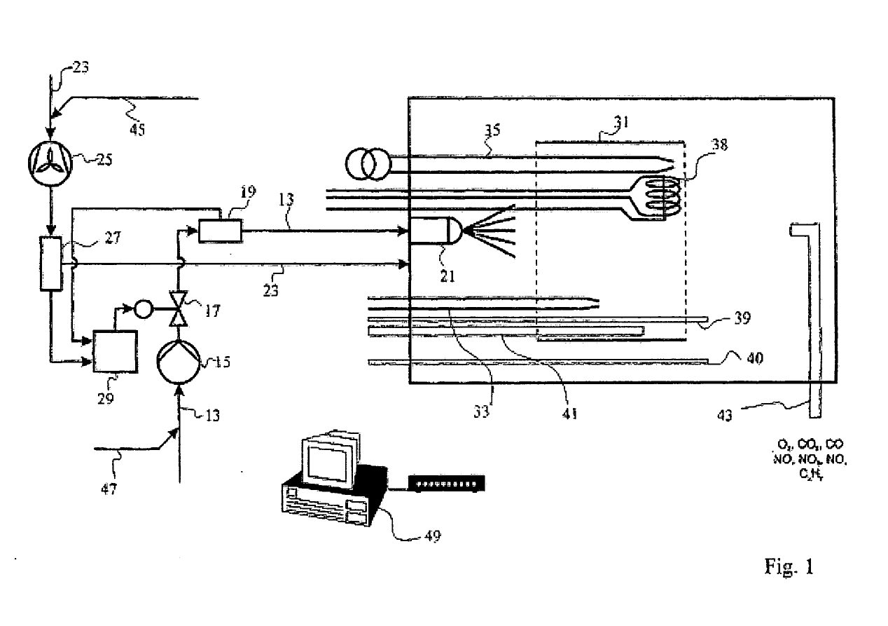

FIG. 1 is a schematic of the test device,

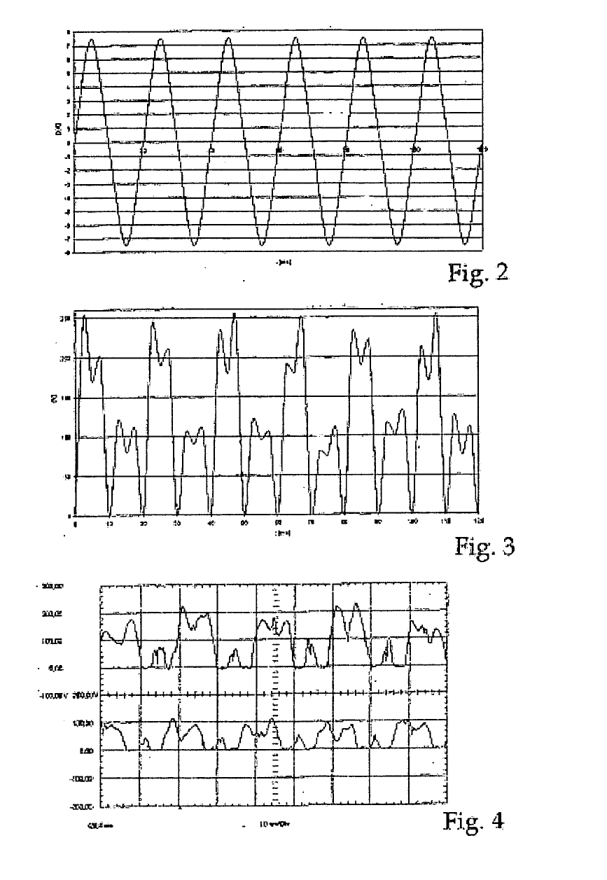

FIG. 2 is a schematic curve of an alternating voltage fed into the plasma of the combustible or fuel to be tested

FIG. 3 is a schematic curve of the voltage measured in the plasma resulting from supplied voltage the according to FIG. 2,

FIG. 4 shows two curves of voltages measured in the plasma in real terms,

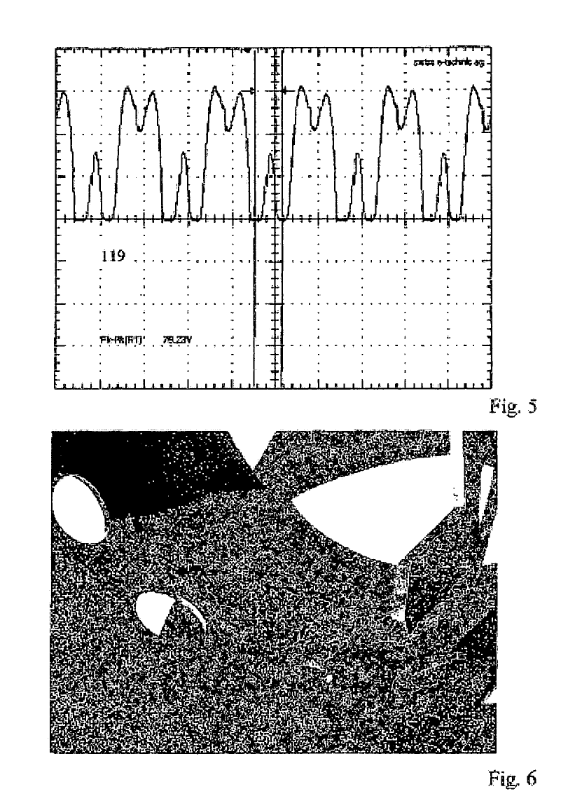

FIG. 5 is a voltage curve measured and averaged on the test specimen 119,

FIG. 6 is a picture of the test specimen 119 after conducting the visual testing method,

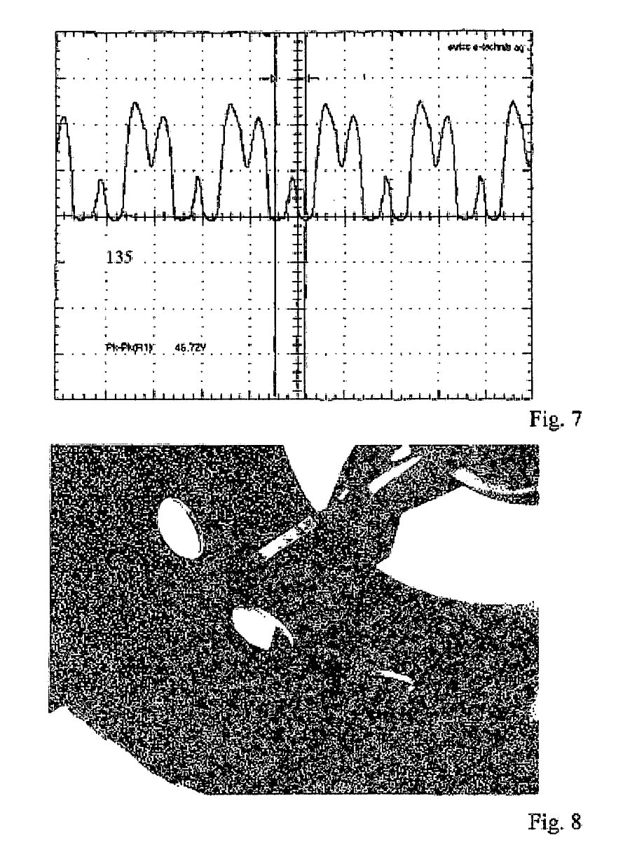

FIG. 7 is a voltage curve measured on the test specimen 135,

FIG. 8 is a picture of the test specimen 135 after conducting the visual testing method,

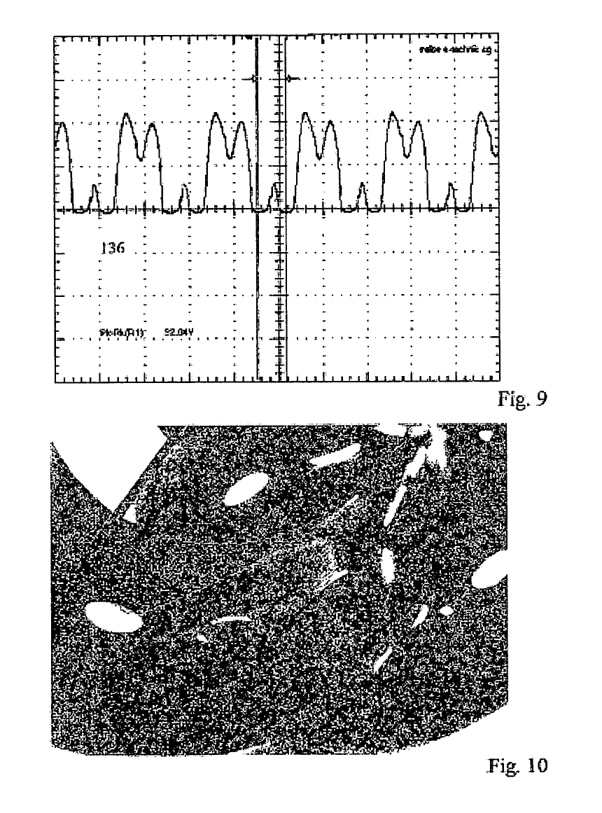

FIG. 9 is a voltage curve measured on the test specimen 136,

FIG. 10 is a picture of the test specimen 136 after conducting the optical testing method,

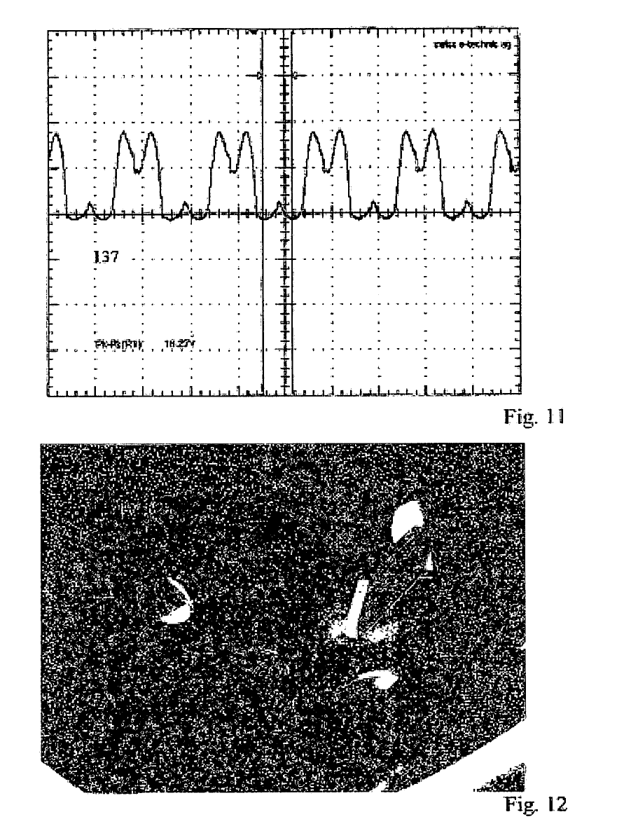

FIG. 11 is a voltage curve measured on the test specimen 137,

FIG. 12 is a picture of the test specimen 137 after conducting the visual testing method,

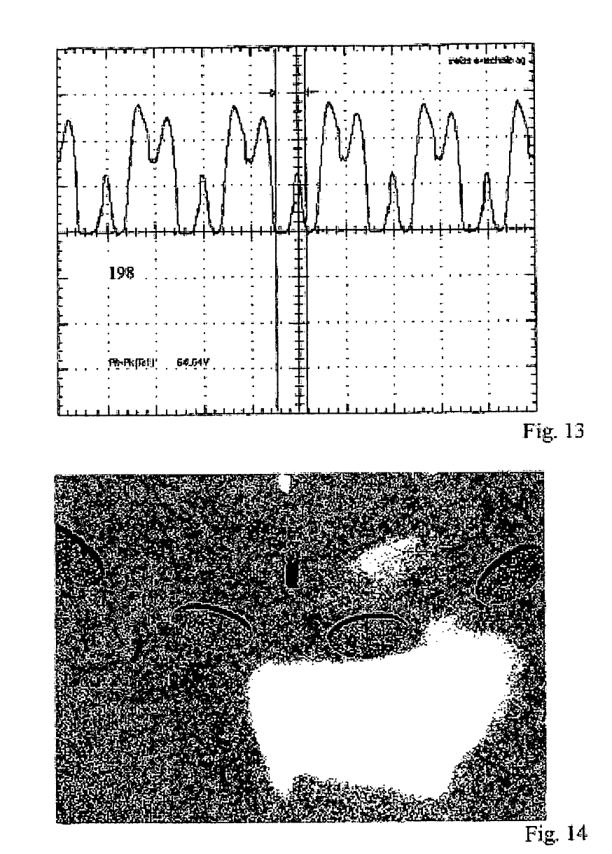

FIG. 13 is a voltage curve measured on the test specimen 198,

FIG. 14 is a picture of the test specimen 198 after conducting the visual testing method,

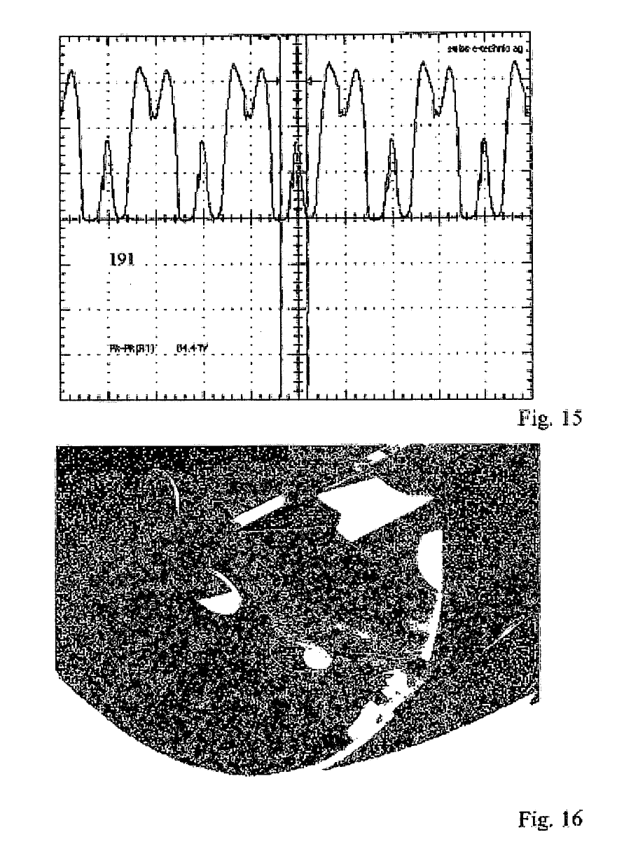

FIG. 15 is a voltage curve measured on the test specimen 191,

FIG. 16 is a picture of the test specimen 191 after conducting the visual testing method,

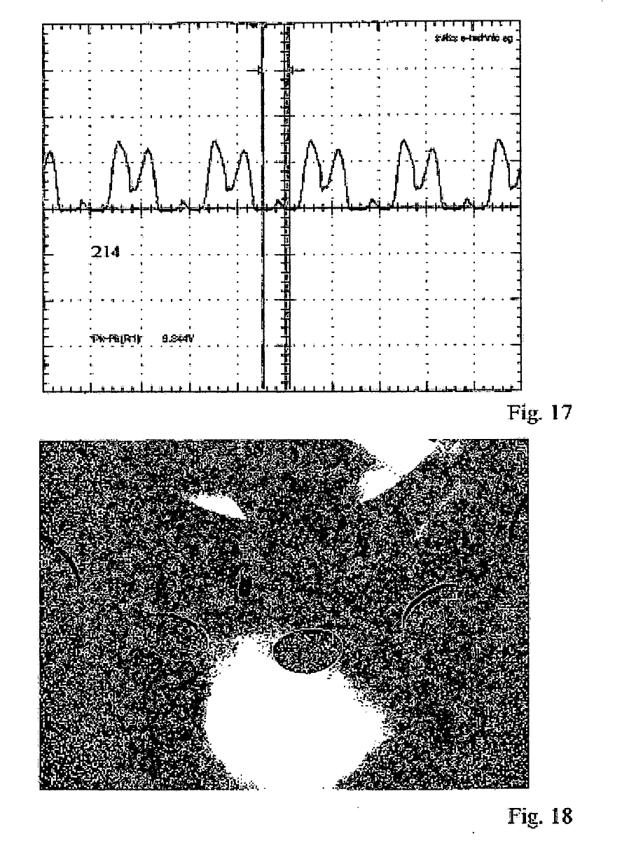

FIG. 17 is a voltage curve measured on the test specimen 214,

FIG. 18 is a picture of the test specimen 214 after conducting the visual testing method,

In FIG. 1 a schematically illustrated test device comprises a plasma chamber 11, in which the test conditions can be produced and measuring instruments for measuring parameters are disposed. The plasma chamber 11 here is a combustion chamber for testing the electrical behavior of a combustible plasma during the combustion of the combustible. Since the erosivity of a combustible develops during the combustion thereof, this device is therefore suitable for determining the erosivity of a combustible. The device, in sequence in the flow direction, comprises a combustible pump 15 on a combustible supply line 13, a combustible volume control 17, a combustible volume sensor 19 and finally a combustible nozzle 21. The combustible can flow into the plasma chamber 11 from the combustible nozzle 21. On a combustion air inlet 23, which also ends in the plasma chamber, the device comprises in the flow direction a blower 25 and a combustion air volume flow sensor 27. An electronics unit 29 regulates the combustible and air quantities based on measurements of the combustion air volume flow sensor 27 and the combustible volume sensor 19.

Also disposed in the plasma chamber 11 are: an evaporator/mixer tube 31 as a test specimen made of a material commonly used for flame cups, a pair of ignition electrodes 33 for igniting the combustion/air mixture, a pair of electrodes 35 for introducing the alternating voltage or direct voltage into the plasma, a plasma sensor (for example a Langmuir probe), an ionization test electrode 39 (anode) for measuring a voltage between the test specimen 31 and the ionization test electrode 39 for a voltage between a second ionization test electrode 40 (cathode) and the first ionization test electrode 39. Furthermore, for monitoring parameters a measuring gas pipe 41 is used for measuring the gas composition inside the flame or the plasma and a measuring gas pipe 43 for measuring the combustion gases after combustion. Furthermore, various sensors are available for monitoring further parameters, such as the air temperature and relative humidity of the combustion air, which are not illustrated in the schematic according to FIG. 1. With a data processing unit 49, different data are processed and illustrated.

In order to standardize the combustion gas quality, the combustion air line 23 may comprise a supply line 45, through which gaseous additives can be added to the combustion air.

In order to influence the combustible, a connecting line 47 is connected to the combustible supply line 13, via which an additive can be added to the combustible in metered quantity.

During the testing of a liquid combustible, the combustible is injected in a metered quantity into the plasma chamber 11. At the same time combustion air is fed into the plasma chamber. For testing a gaseous combustible, the combustion air is mixed with the gaseous combustible and supplied to the plasma chamber.

The gaseous or liquid combustible is ignited in the plasma chamber by feeding energy via the ignition electrodes 33. A plasma is thus formed from the combustible and burns in reaction with the combustion air. An alternating voltage is then fed into the plasma via the electrodes 35. This alternating voltage is rectified by the plasma. The resulting voltage curve between the ionization test electrode 39 and the test specimen 31 is recorded and the ionization of the plasma measured. The parameters are monitored during the measurement of the ionization. The measurement is verified as soon as the parameters correspond to fixed reference values. The values measured with the ionization test electrode 39 are meaningful in terms of the combustible's tendency to erode the test specimen. The measured values can now also be visually tested by carrying out the testing method disclosed in WO03027886 immediately after the measurement on the same test specimen 31.

A voltage is generally present in every plasma and therefore in every flame. This voltage is also present independently of any external voltage. Measurements are therefore also possible without external voltage. The voltage of the plasma, however, is increased by the external voltage, regardless of whether it is direct voltage or alternating voltage. The voltage can have almost any values greater than 0. In the case of alternating voltage and direct voltage, potentials in the range of only 100 to 300 V can have a reinforcing effect on the measured values.

In the device shown in FIG. 1, also a cathode 40 is provided in addition to the test specimen 31. This is particularly suitable when the plasma chamber 11 is, for example, an existing combustion chamber of a heating system. In this case, the supply lines for the combustion air and the gaseous or liquid combustible are likewise provided and are not part of the test device. It is also possible that no evaporator 31 is provided, which could serve as a test specimen and cathode. In these cases, the test device must comprise a second ionization measuring electrode 40. A test device of this kind can therefore be disposed in any given combustion chamber. For this reason, it only comprises the parts necessary for applying the voltage field and for measuring the electrical behavior of the plasma, such as the electrodes 35 and plasma sensor 38 (for example Langmuir probe) and/or ionization test electrodes 39, 40.

The sinusoidal alternating voltage fed into the plasma in the examples, as that shown in FIG. 2, has a voltage peak of 7500 V and a frequency of 50 Hz. At this alternating voltage, a pulsating direct voltage is measured between the ionization test electrode 39 and the test specimen 31. Such pulsating direct voltage is schematically illustrated in FIG. 3. The anode is formed by the ionization test electrode 39 inside the test specimen 31 disposed in a ring shape around the anode, which specimen in turn forms the cathode. This pulsating direct voltage has alternately higher first and lower second voltage peaks. The higher voltage peak runs parallel to the fed alternating voltage, the voltage pulse with the lower voltage peak occurs at the same time as the alternating voltage directed in opposite direction. Therefore, it can be said that the alternating voltage fed into the plasma is rectified, wherein the converted second half wave reaches substantially lower values than the non-converted first half wave. For both half waves, the apex ranges have collapsed comparison with a sinusoidal curve. The measured voltage peaks for combustibles (untreated from the refinery or treated by adding additives) range under 400V for the first half wave and under 150 V for the second half wave.

The combustible erosivity is best visible from the averaged value of the voltage peaks. Most liquid combustibles with very low sulfur contents are erosive. With these problem combustibles, the measured average values for the voltage peaks of the second half waves in the applicant's test device range between 68 V and 110 V. The measured average values for the voltage peaks of the first half waves are greater than 140 V.

Unproblematic combustibles in an untreated state have averaged voltage peaks of the second half wave of at most 68 V. Combustibles with higher values of the second half wave must be treated by adding additives. Two ranges exist, within which the voltage peaks indicate a combustible rendered unproblematic by its treatment with additives. Combustible are on one hand unproblematic when the average values of the 1^{st} half wave are, for example, lower than 30 V and the average values of the 2^{nd} half wave are smaller than 10 V. The lower the measured values, the more the plasma behaves as a dielectric. On the other hand, adding additives can also render combustibles unproblematic, in that the average values of the 1^{st} half wave are raised above 200 V and the average values of the 2^{nd} half wave above 120 V. The higher the measured values, the more conductive the plasma. It has to be assumed that by increasing the conductivity of the plasma a low charge potential can be provided.

The aforementioned values may shift within limits (approx. ±20 V), as a function of the basic setting of the parameters. In the laboratory test of the applicant, values of the 1^{st} half wave higher than 140 V and values of the 2^{nd} half wave higher than 68 V are considered critical average values. The erosivity assessment of the combustible is substantially based on the values of the 2^{nd} half wave, wherein the values of the first half wave are used for evaluating the second half wave.

The measuring signals of a selected batch of combustible are illustrated in FIG. 4. The top values were measured on the untreated combustible. These values are in a clearly critical range. The combustible must be considered very risk-prove due to the voltage peaks of up to 100 V of the second half waves. Lower values are measured after adding additives, which increases the dielectricity of the plasma or of an oxide film on the surface of a metallic test specimen. The measured and averaged voltage peaks of the second half wave under 50 V indicate that the addition of an additive rendered the combustible uncritical.

The measured values before and after the addition of additives have to be assessed. Depending upon the measured values of the untreated combustible, the measured values of the treated combustible must be interpreted differently. It is assumed that the higher the measured values of the untreated batch, the lower the setting of measured values of the treated batch has to be.

An untreated combustible of a selected batch (internal designation CH—B) is tested with the test specimen no. “119”. The measured values of this test are illustrated in FIG. 5. The averaged voltage peaks reach values of 157 V for the first half wave and 79.5 V for the second half wave. Based on these values, the combustible must be classified as extremely risk-prone. Accordingly, after carrying out the testing disclosed in WO 03027668, an erosion surface measuring a few square centimeters is determined on the test specimen no. “119”. The visible surface change of the test specimen 119 is illustrated in FIG. 6.

The same combustible, to which 0.3% of an additive (internal designation “SET 100”) is added, is tested with the test specimen no. “135”. The measured values of this test are illustrated in FIG. 7. The averaged voltage peaks reach values of 126 V for the first half wave and 46 V for the second half wave. Based on these values, the combustible still must be classified as very risk-prone. After carrying out the testing disclosed in WO 03027668, an erosion surface measuring about a third square centimeter is determined. The visible surface change of the test specimen no. “135” is illustrated in FIG. 8.

The same combustible, to which now 0.5% of the additive is added, is tested with the test specimen no. “136”. The measured values of this test are illustrated in FIG. 9. The averaged voltage peaks reach values of 115 V for the first half wave and 33 V for the second half wave. Based on these values, the combustible still must be classified as very risk-prone. After carrying out the test disclosed in WO 03027668, a clearly noticeable erosion surface is determined on the test specimen 136. The visible surface change of the test specimen no. “136” is illustrated in FIG. 10.

The same combustible, to which now 0.8% of the additive is added, is tested with the test specimen no. “137”. The measured values of this test are illustrated in FIG. 11. The averaged voltage peaks reach values of 94.5 V for the first half wave and over 18 V for the second half wave. Based on these values, the combustible still must be classified as very risk-prone. After carrying out the testing disclosed in WO 03027668, a small erosion surface is determined on the test specimen no. “137”. The visible surface change of the test specimen no. “137” is illustrated in FIG. 12.

This series of tests of a combustible with additions of varying quantities of an additive demonstrates that solution approaches for solving a discovered problem can be assessed with the method according to invention. If, for example, no solution is reached with 0.8% of an additive, and thus with 8000 ppm, it is clear that other ways must be researched. The additive turns out to be unsuitable here to sufficiently lower the erosivity of the combustible. An efficient solution should require less than 2000 ppm of the additive.

A standard combustible comprising approx. 740 mg sulfur and 120 mg nitrogen (internal designation “Waldburger”) is tested with the test specimen no. “198”. The measured values of this testing are illustrated in FIG. 13. The averaged voltage peaks reach values of 78 V for the first half wave and 9.8 V for the second half wave. Based on these values, the fuel must be classified as not risk-prone. After carrying out the testing disclosed in WO 03027668, no erosion surface is determined on the test specimen no. “138” (FIG. 14). The addition of an additive is not necessary.

Another combustible (internal designation “oeko JF”) is tested with the test specimen no. “191”. The measured values of this testing are illustrated in FIG. 15. The averaged voltage peaks reach values of over 160 V for the first half wave and 84.41 V for the second half wave. Based on these values, the combustible must be classified as highly risk-prone. After carrying out the testing disclosed in WO 03027668, an excessive erosion surface is determined on the test specimen no. “191” (FIG. 16).

The same combustible (“oeko JF”), to which 0.243% of an additive (internal designation “ADD 36”) is added, is tested with the test specimen No. “214”. The measured values of this testing are illustrated in FIG. 17. The averaged voltage peaks reach values of just under 75 V for the first half wave and 9.8 V for the second half wave. Based on these values, the combustible mixed with this amount of additive can be classified as not risk-prone. After carrying out the testing disclosed in WO 03027668, no erosion surface is determined on the test specimen no. “214” (FIG. 18).

For testing liquid and gaseous fuels and combustibles in general and for testing the erosivity of low-sulfur combustibles in particular, in summary it can be stated that a plasma is formed with the combustible or fuel and the electrical behavior of the plasma is measured. The more dielectric the plasma of an untreated batch of combustible or fuel is, the less risk-prone the combustible or fuel. The conductivity of the plasma can be increased or lowered by adding additives in order to obtain an unproblematic fuel or combustible in terms of erosivity. The measured values of the voltage peaks of the half wave, converted by the plasma, of an alternating voltage applied to the plasma of combustibles and fuels that are treated by means of additives must be lower, or significantly greater, than the corresponding measured values of a combustible or fuel which is already unproblematic in untreated state.

1-21. (canceled)

22. A method for testing of a liquid or gaseous fuel, comprising:
forming a plasma with the fuel; and
measuring the electrical behavior of the plasma.

23. The method according to claim 22, comprising testing the erosivity of the fuel in a combustion chamber.

24. The method according to claim 22, comprising forming a plasma in a low-sulfur fuel and testing the erosivity of the fuel.

25. The method according to claim 22, comprising measuring a potential, a current flow, or a combination thereof between two test electrodes disposed in the plasma.

26. The method according to claim 25, wherein the electrical potential, the current flow, or a combination thereof is measured between a test electrode and a portion of a combustion chamber.

27. The method according to claim 25, comprising actively introducing an electrical voltage in the plasma at the same time the potential, the current flow or combination thereof is measured.

28. The method according to claim 27, comprising introducing an alternating electrical voltage.

29. The method according to claim 27, comprising introducing a direct electrical voltage.

30. The method according to claim 28, wherein the alternating electrical voltage is applied by two electrodes (33) disposed in the plasma.

31. The method according to claim 29, wherein the direct electrical voltage is applied by two electrodes (33) disposed in the plasma.

32. The method according to claim 27, comprising applying an electrical voltage to the fuel to generate a plasma.

33. The method according to 22, comprising burning the fuel.

34. The method according to claim 22, further comprising:
treating a fuel with an additive;
measuring a potential curve of a measured voltage between the test electrodes for the fuel with the additive;
measuring a potential curve of a measured voltage between the test electrodes for a fuel lacking the additive; and
analyzing the measured potential curve for the fuel treated with the additive against the measured potential curve for the fuel lacking the additive.

35. The method according to claim 28, comprising evaluating a maximum value of a second half wave in the plasma.

36. The method according to claim 35, further comprising evaluating a maximum value of a first half wave.

37. The method according to claim 35, comprising calibrating a test device based on at least one comparison fuel.

38. The method according to claim 22, wherein at least one parameter selected from the group consisting of geometry, material and temperature of a test specimen, material and position of a test electrode, CO₂ content, O₂ content, CO content, SO content, SO₂ content, NO content, NO₂ content, CxHy content, soot levels, soot particles, pressure of the plasma in front of a nozzle, nozzle type, spray angle, pressure in an evaporation zone, pressure in a combustion zone, pressure at an air intake, temperature and relative humidity of a combustion atmosphere, combustion efficiency, material comprising a combustion chamber cooling system, air flow geometry of a combustion air at an entry to an evaporator, a reference combustible, or a combination thereof, is maintained within limit value during testing.

39. A device for testing a combustible, comprising:
a plasma chamber;
a means for introducing a combustible fuel into the plasma chamber;
a means for producing a plasma from the combustible fuel;
a cathode and an anode as test electrodes; and
a device for measuring and electronically processing electrical values determined by the test electrodes.

40. The device of claim 39, wherein the device is configured to test the erosivity of combustion conditions during combustion of the combustible fuel.

41. The device of claim 40, wherein the device comprises:
at least one of the following means for influencing the potential in a plasma of a combustible fuel:
one or two electrodes and a voltage source connected thereto or a sacrificial anode.

42. A method for testing a liquid or gaseous fuel, said method comprising:
forming a plasma with the fuel;
introducing an alternating electrical voltage in the plasma;
measuring an electrical behavior of the plasma; and
evaluating a maximum value of a second half wave in the plasma.
